(19) United States
(12) Patent Application Publication
(10) Pub. No.: US 2013/0166575 A1
(43) Pub. Date: Jun. 27, 2013

(54) DATABASE DISPLAING OR RECORDING EVENTS BY TIME SEQUENCE AND METHOD THEREOF

(71) Applicant: Jiaher Lee, Taipei City (TW)

(72) Inventor: Jiaher Lee, Taipei City (TW)

(21) Appl. No.: 13/332,366

(22) Filed: Dec. 21, 2011

(51) Int. Cl. G06F 17/30

(52) U.S. Cl. 707/752; 707/E17.005

(57) ABSTRACT

A database of displaying or recording events by time sequence and a method thereof, particularly a database that displays and records the events with different title data in a single cross-year list are disclosed. The method of displaying and recording the database includes displaying a plurality of time marks through a user interface, sequentially arranging and stacking a plurality of data blocks under the time marks, and each data block includes a title field and a data field, and title data are disposed in the title fields, and a plurality of event data is disposed in the matched data fields of the title data according to event content and time of occurrence and under the time marks, so that the event data indifferent data blocks are compared with one another based on the time marks, so as to improve the convenience of data comparison.

### BACKGROUND OF THE INVENTION

1. Field of the Invention

The present invention relates to a database displaying or recording events by time sequence, in particular to the database for displaying and recording data of events with different titles in a single cross-year list, and the method of displaying and recording the database, and relates to a user interface for displaying or recording the content of the database, particularly relates to a time mark, a data block, a title field, a data field, title data and event data on the user interface.

2. Description of the Prior Art

As the database technology advances, users can accumulate and edit a large quantity of data with different titles, and a database is generally installed in a user's computer or a remote server with the Internet as a base, and many users can jointly access a single database, and the data added, deleted and operated by each user can be saved in the database.

Therefore, each user can provide data to the database in a cooperative manner or develop data in the database, so that each user can search, read and compare data.

In addition, the traditional way of searching data in a database is to browse all data in the database first and find the required data. The present existing database search methods also include inputting a keyword of a title to search for the content of a database, and searching the content of a database through a plurality of pre-defined title classes.

However, event data found by the aforementioned search method are displayed in a scattered form on a user interface (such as a computer screen), such that when a plurality of event data with different titles are displayed, each record of data still cannot be displayed simultaneously on the user interface, and the user needs to adjust or switch the user interface before the data can be compared, thus making the data comparison more difficult, and this is a problem that requires feasible solutions.

### SUMMARY OF THE INVENTION

Therefore, it is a primary objective of the present invention to provide a database that displays and records data of events with different titles on a single cross-year list, and a method of displaying and recording the database to overcome the problems of the prior art that the searched data from the database are displayed in a scattered manner and the comparison of data is difficult, and the present invention can improve the convenience of the data comparison.

To achieve the foregoing objective, the present invention provides a database displaying or recording events by time sequence on a user interface, and the database comprises:

a plurality of time marks, arranged according to a time sequence;

a plurality of data blocks, vertically superimposed under the time marks, and each of the data blocks including a title field and a data field disposed adjacent to each other, and the data field being disposed under the corresponding time mark;

a plurality of title data, having a quantity equal to the quantity of the data blocks, and disposed in the title field; and

a plurality of event data, stored in the data field with the matched title data according to the content and the time of occurrence of an event and under the time mark, and arranged according to the sequence of the time of occurrence of the events, and the event data in a different data block being compared with each other based on the time mark.

Therefore, the event data with the same title data can be displayed or recorded in the data field of the database according to the time sequence, and the event data with different title data can be arranged adjacent to one another, and compared with each other based on the time mark, so that the event data with different title data of the database can be displayed and recorded in the single cross-year list to improve the convenience of data comparison.

The database of the present invention further comprises the following:

The title field is disposed adjacent to the data field.

The data block has a time range tag disposed under the data block, and the time range tag is adjusted to reduce or enlarge a display range of the time mark and the data field.

Each of the event data include an event mark and an event tag disposed adjacent to each other, and the event mark is extended according to time interval of occurrence to an opposite end below a position between the time marks to select an event tag, and an editing window capable of displaying and recording the even content appears.

The event tag is disposed under the event mark, and the adjacent event tags are stacked with one another, and each event tag contains texts or pictures of the event content.

The editing window contains texts, pictures, videos, movies or hyperlinks of the event content, and each of both ends of the editing window has a switching mark, and the switching mark is selected to switch to an editing window of the event data.

The data block has an event editing block disposed under the data block and corresponding to the editing window, and the event editing block can display and record the event content, and the event editing block contains texts, pictures, videos, movies or hyperlinks of the event content.

In addition, the present invention further provides a method of displaying or recording events by time sequence, and the method comprises the following steps:

Provide a plurality of time marks arranged sequentially according to a time sequence, and display them on a user interface.

Search a plurality of title data one by one on the user interface, and vertically stack a data block of the title data under the time mark, and each of the data blocks includes a title field and a data field disposed adjacent to each other, and the data field is disposed under the time mark, and the title data are disposed in the title field.

Finally, display or list a plurality of event data in the matched data fields of the title data according to event content and time of occurrence and under the time marks, and the event data are arranged sequentially according to the time of occurrence of the events, and the event data in different data blocks are compared with one another based on the time marks.

Therefore, the event data of different title data of the database can be displayed and recorded in a single cross-year list to improve the convenience of the data comparison.

The method of the present invention further comprises the following steps:

Adjust a time range tag under the data block to reduce or enlarge a display range of the time mark and the data field.

Each of the event data includes an event mark and an event tag disposed adjacent to one another, and the event mark is extended to an opposite end under a position between the time marks according to the time interval of occurrence of the event, and the event tag is selected, such that an editing window capable of displaying and recording the event content appears.

Each of both ends of the editing window has a switching mark, and the switching mark is selected to switch to an editing window of the next event data.

The data block has an event editing block disposed under the data back and corresponding to the editing window, and the event editing block can display and record the event content, and the event editing block can be selected to record the event content.

### BRIEF DESCRIPTION OF THE DRAWINGS

FIG. 1 is a schematic view of the configuration of a database of the present invention;

FIG. 2 is a partial close-up view of FIG. 1;

FIG. 3 is a schematic view of a using status of FIG. 1;

FIG. 4 is another schematic view of a using status of FIG. 1;

FIG. 5 is a schematic view of a next using status of FIG. 4;

FIG. 6 is a schematic view of a next using status of FIG. 5;

FIG. 7 is a schematic view of the configuration of an event editing block in according to an embodiment as depicted in FIG. 1;

FIG. 8 is a schematic view of a further use status of FIG. 1; and

FIG. 9 is a flow chart of a method of the present invention.

### DETAILED DESCRIPTION OF THE PREFERRED EMBODIMENTS

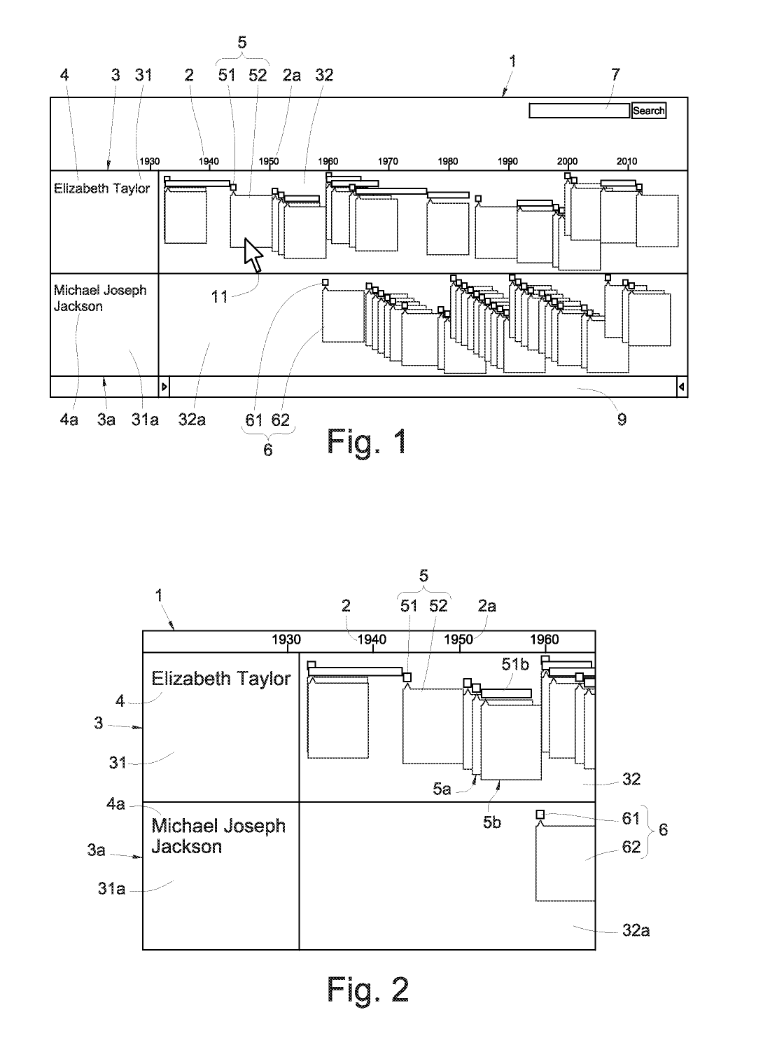

With reference to FIG. 1 for a schematic view of the configuration of a database of the present invention, the invention provides a database that displays or records events by a time sequence, wherein a user interface 1 is provided for displaying title data 4 including a plurality of time marks 2, 2a, a plurality of data blocks 3, 3a, a plurality of title data 4, 4a with the same quantity of the data blocks 3, 3a and a plurality of event data 5, 6.

The time mark 2 can be a unit of time such as a second, a minute, a hour, a day, a week, a month, a quarter, a year, a century, and an era, and this preferred embodiment adopts AD for the year (such as 1930), and each time mark 2, 2a is arranged sequentially according to a time sequence and 10 and equidistantly in the unit of a decade apart from one another, so that the time marks 2, 2a may include 1930, 1940, 1950 . . . and 2010 AD. The time marks 2, 2a include a search window 7 disposed above the time marks 2, 2a.

The data blocks 3, 3a have a profile substantially in a long-strip, and the quantity of data blocks 3, 3a can be two or more. In this preferred embodiment, the data blocks 3, 3a can be divided into a first data block 3 and a second data block 3a, and the first and second data blocks 3, 3a are arranged and stacked vertically under the time mark 2, and each of the first and second data blocks 3, 3a includes a title field 31, 31a and a data field 32, 32a disposed adjacent to each other (as shown in FIG. 2), and the title fields 31, 31a are disposed adjacent to the data fields 32, 32a respectively, and the data fields 32, 32a are disposed under the time mark.

The title data 4, 4a can be texts, numerals or symbols, and the title data 4, 4a of this preferred embodiment can be divided into first title data 4 and second title data 4a, and the first title data 4 are disposed in the first title field 31, and the second title data 4a are disposed in the second title field 31a, and the first title data 4 of this preferred embodiment adopts Elizabeth Taylor as an example, and the second title data 4a of this preferred embodiment adopts Michael Joseph Jackson as an example.

The event data 5 of this preferred embodiment can be event data related to Elizabeth Taylor, and the event data 6 of this preferred embodiment can be event data related to Michael Joseph Jackson, and each of the event data 5, 6 includes an event mark 51, 61 and an event tag 52, 62 disposed adjacent to each other.

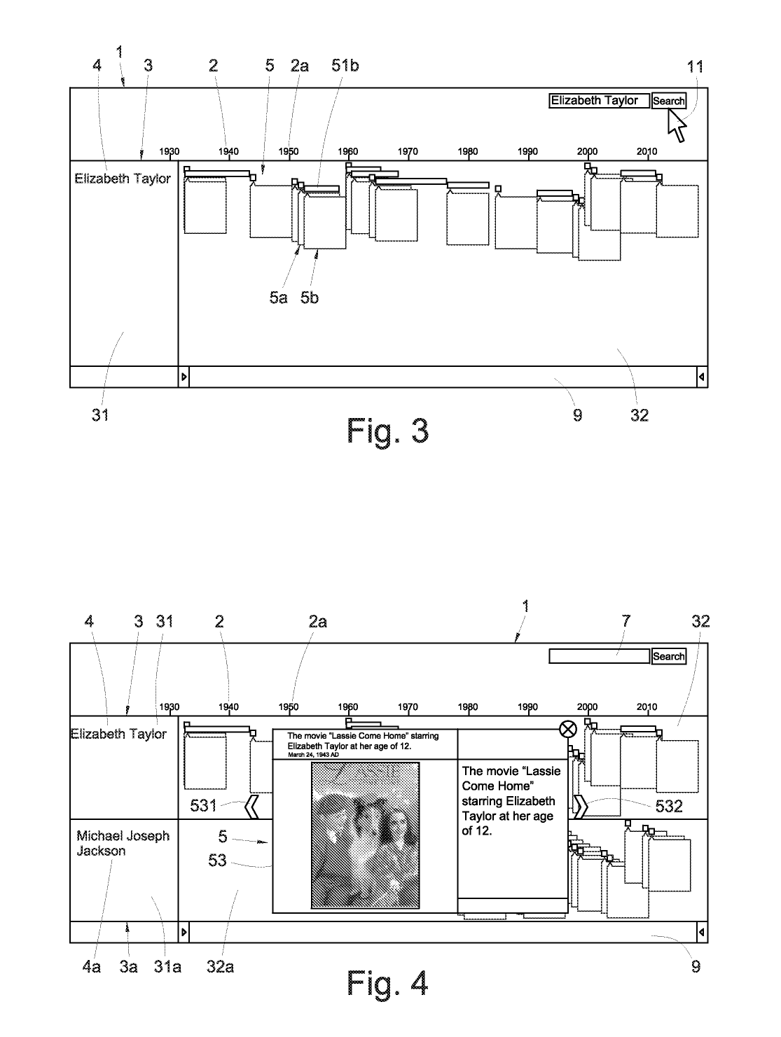

Each of the event data 5, 6 is filled in a matched data field 32, 32a of the corresponding first and second title data 4, 4a according to the event content, and disposed under the matched time mark 2 according to the time of occurrence of the event. For example, the content of the event data 5 is Mar. 24, 1943 AD which relates to the data about the movie “Lassie Come Home” starring Elizabeth Taylor at her age of 12 (as shown in FIGS. 3 and 4), so that the event data 5 are listed in the data field 32 of the first title data 4 and disposed under a position between the time mark 2 of the year 1940 AD and the time mark 2 of the year 1950 AD.

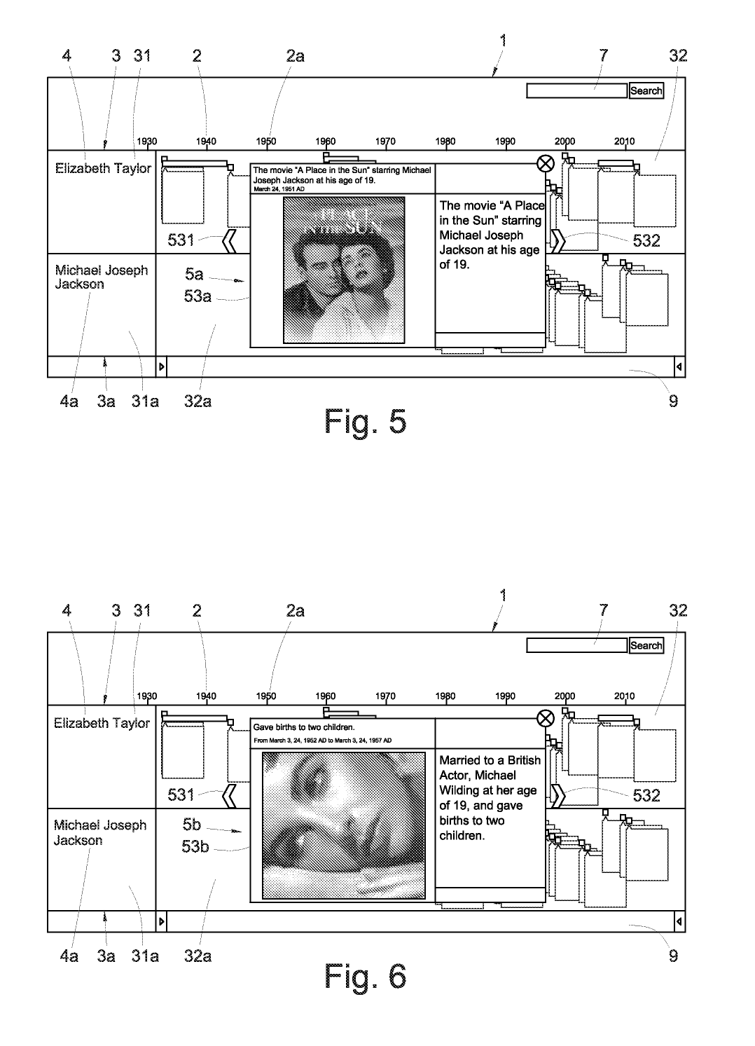

The event data 5, 6 are arranged sequentially in a descending order according to the time of occurrence of the events. For example, the content of the event data 5a is Mar. 24, 1951 AD which relates to the movie “A Place in the Sun” starring Elizabeth Taylor at her age of 19 (as shown in FIG. 5), and the content of the event data 5b ranges from Mar. 24, 1952 AD to Mar. 24, 1957 AD which relates to the data regarding the marriage, childbirth and divorce of Elizabeth Taylor and a British actor Michael Wilding (as shown in FIG. 6), so that the event data 5b are arranged under the event data 5a.

The event mark 51, 61 can form a small square at a time point of the occurrence of the event, or can be extended to an opposite end under a position between the time marks 2, 2a according to the time interval of occurrence. For example, the event data 5b relate to the events from the marriage to the divorce of Elizabeth Taylor and cross the time from Mar. 24, 1952 AD to Mar. 24, 1957 AD, so that the event mark 51b of the event data 5b is extended to a specific length to an opposite end under a position between the time marks 2, 2a, such that the event mark 51b is in the shape of a long strip, and the specific length is corresponsive to a time calibration between the time marks 2, 2a to facilitate users to determine the time interval of occurrence of the event.

The event tag 52, 62 is disposed under the event mark 51, 61 and adjacent event tags 52, 62 are stacked with one another, and the event tag 52, 62 contains texts or pictures of the event content to facilitate users to search data quickly.

If a cursor 11 is used to select the event tag 52, a editing window 53 capable of displaying and recording an event content pops out (as shown in FIG. 4) to facilitate users to briefly read and edit the recorded data. The selection method can be a click by the cursor 11 or a touch by the cursor 11 to a desired target such as the tag 52, 62. The editing window 53 contains texts, pictures, videos, movies or hyperlinks of an event content, and each of both ends of the editing window 53 has a switching mark 531, 532, and the switching mark 531, 532 can be selected to switch to an editing window 53a, 53b of the next event data 5a, 5b (as shown in FIGS. 5 and 6).

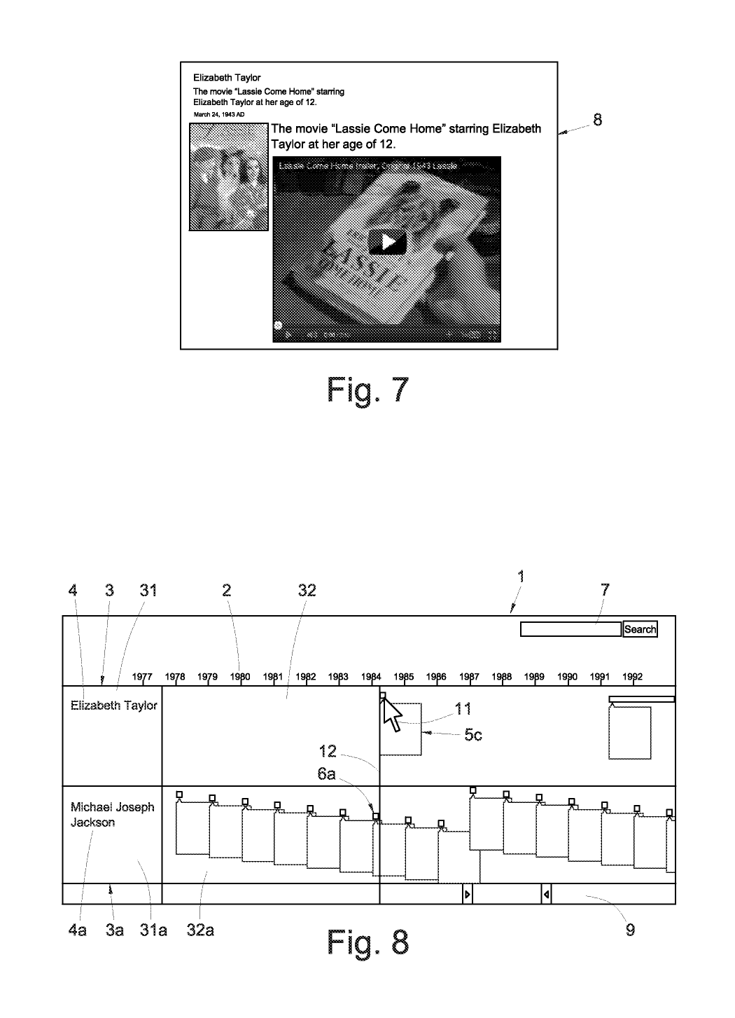

When the cursor 11 is used to select the event tag 52, an event editing block 8 corresponding to the editing window 53 appears under the first and second data blocks 3, 3a (as shown in FIG. 7), and the event editing block 8 can display and record an event content, and the event editing block 8 contains texts, pictures, videos, movies or hyperlinks of the event content and displays more detailed data for users to read and edit or record a large quantity of data.

Therefore, the different event data 5, 5a, 5b, 6 in the first and second data blocks 3, 3a can be compared with each other based on the time marks 2, 2a.

Each of the first and second data blocks 3, 3a also has a time range tag 9 disposed under the data block 3, 3a, and users can use the cursor 11 to adjust the time range tag 9 to reduce or enlarge the display range of the time mark 2, 2a and the data field 32, 32a (as shown in FIG. 8) to facilitate users to view the event data 5, 5a, 5b, 6 in the first and second data blocks 3, 3a in details, so as to provide a position preview function. When the cursor 11 is used to select the event data 5c in the data field 32 of the first data block 3, a perpendicular line 12 shows up between the time mark 2, 2a and the data field 32, 32a, and spans across a range between the event data 5c and other event data 6a of the second data block 3a to facilitate users to compare the event data 5, 5a, 5b, 6, 6a of the first and second data blocks 3, 3a.

Therefore, the event data 5, 5a, 5b, 6, 6a with the same title data 4, 4a can be displayed or recorded in the data fields 32, 32a of the database according to the time sequence, and the event data 5, 5a, 5b, 6, 6a with different title data 4, 4a can be arranged adjacent to one another, and compared with one another based on the time marks 2, 2a, and the event data 5, 5a, 5b, 6, 6a with different title data 4, 4a of the database can be displayed and recorded in a single cross-year list, and further shown on the user interface at the same time, so that users need not to adjust or switch the user interface during the period of comparing data, so as to overcome the aforementioned problems of the prior art, since the conventional way of searching data from a database gives the result of scattered data and the difficulty for the data comparison. The invention can improve the convenience of the data comparison effectively.

In addition, when the aforementioned event data are pure numeric data, the event mark and the event tag of the event data can be omitted, so that the event data can be distributed in the data fields 32, 32a in form of single dots, so that a line can be used to connect the single-dot event data in the same data fields 32, 32a to form a line graph, or the single-dot event data can be used to form a statistical chart such as a histogram, a box plot, and a biplot.

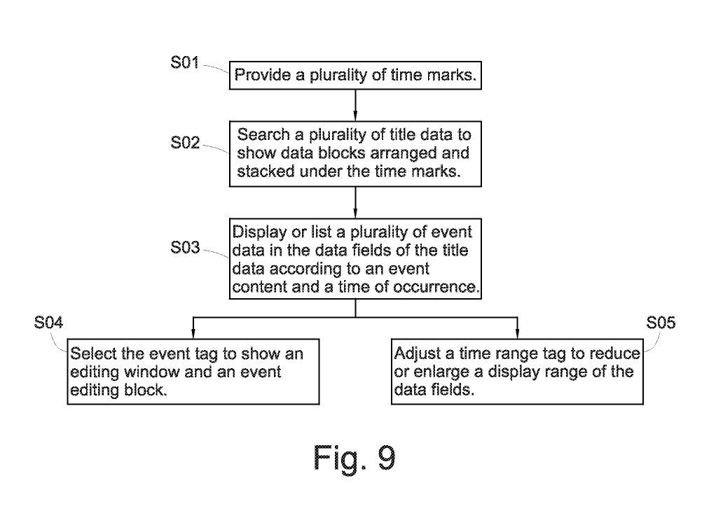

With reference to FIG. 9 for a block diagram showing a flow chart of a method of displaying or recording events by a time sequence in accordance the present invention, the method of the present invention comprises the following steps:

S01: Provide a plurality of time marks 2, 2a sequentially arranged according to the time sequence on the user interface 1 (as shown in FIG. 3).

S02: Use a search window 7 to search a plurality of title data 4, 4a one by one on the user interface 1 (as shown in FIGS. 1 and 2), and arrange and stack a first data block 3 of the first title data 4 and a first data block 3a of the second title data 4a under the time marks 2, 2a, wherein each of the first and second data blocks 3, 3a includes a title field 31, 31a and a data field 32, 32a disposed adjacent to each other, and the data fields 32, 32a are disposed under the time marks 31, 31a respectively, and the first and second title data 4, 4a are disposed in the title fields 32, 32a respectively.

S03: Display or list a plurality of event data 5, 5a, 5b, 6 into the matched data fields 32, 32a of the first and second title data 4, 4a according to an event content and a time of occurrence, and sequentially arranging the event data 5, 5a, 5b, 6 under the matched time marks 2, 2a respectively according to the time of occurrence of the events, and sequentially arranging the event data 5, 5a, 5b, 6 according to the time of occurrence of the events, such that the event data 5, 5a, 5b, 6 in different first and second data blocks 3, 3a can be compared with on another based on the time mark 2, 2a.

Each of the event data 5, 6 includes an event mark 51, 61 and an event tag 52, 62 disposed adjacent to each other, and the event mark 51, 61 is extended to an opposite end under a position between the time marks 2, 2a according to a time interval of occurrence.

S04: Select the event tag 52 to show an editing window 53 capable of displaying and recording an event content (as shown in FIG. 4) and an event editing block 8 corresponding to the editing window 53 (as shown in FIG. 7), wherein the editing window 53 has a switching mark 531, 532 disposed separately at both ends of the editing window 53, and the switching mark 531, 532 can be selected to switch to the next editing window 53a, 53b of the event data 5a, 5b (as shown in FIGS. 5 and 6).

The event editing blocks 8 are disposed under the first and second data blocks 3, 3a, and the event editing block 8 can display and record an event content, and the event editing block 8 can be selected to record the event content.

S05: Adjust a time range tag 9 under the first and second data blocks 3, 3a (as shown in FIG. 8) to reduce or enlarge a display range of the time marks 2, 2a and the data fields 32, 32a.

Therefore, the event data 5, 5a, 5b, 6, 6a with different title data 4, 4a of the database can be displayed and recorded in a single cross-year list to improve the convenience of comparing data, and the remaining ways of listing, displaying and recording data are the same as those of the aforementioned embodiments.

What is claimed is:

1. A database displaying or recording events by a time sequence through a user interface, comprising:
a plurality of time marks, sequentially arranged according to the time sequence;
a plurality of data blocks, arranged and vertically stacked with each other under the time marks, and each of the data blocks including a title field and a data field disposed adjacent to one another, and the data field being disposed under the time mark;
a plurality of title data, having a quantity equal to the quantity of data blocks, and disposed in the title fields respectively; and
a plurality of event data, disposed in the matched data fields of the title data according to an event content and a time of occurrence and under the time mark, and the event data being arranged sequentially according to the time of occurrence of the events, and the event data in the different data blocks being compared with one another based on the time marks.

2. The database displaying or recording events by a time sequence according to claim 1, wherein the title field is disposed adjacent to the data field.

3. The database displaying or recording events by a time sequence according to claim 1, wherein the data block has a time range tag disposed under the data block for adjusting the time range tag to reduce or enlarge a display range of the time mark and the data field.

4. The database displaying or recording events by a time sequence according to claim 1, wherein each of the event data includes an event mark and an event tag disposed adjacent to each other, and the event mark is extended to an opposite end under a position between the time marks according to a time interval of occurrence, and the event tag is selected to show an editing window capable of displaying and recording an event content.

5. The database displaying or recording events by a time sequence according to claim 4, wherein the event tag is disposed under the event mark, and the adjacent event tags are stacked with one another, and the event tag contains a text or a picture of the event content.

6. The database displaying or recording events by a time sequence according to claim 4, wherein the editing window contains a text, a picture, a video, a movie or a hyperlink of the event content.

7. The database displaying or recording events by a time sequence according to claim 4, wherein the editing window has a switching mark disposed separately at both ends of the editing window, and the switching mark is selected to switch to an editing window of the next event data.

8. The database displaying or recording events by a time sequence according to claim 4, wherein the data block has an event editing block disposed under the data block and corresponding to the editing window, and the event editing block is capable of displaying and recording an event content, and the event editing block contains a text, a picture, a video, a movie or a hyperlink of an event content.

9. A method of displaying or recording events by a time sequence, comprising:
providing a plurality of time marks arranged sequentially according to the time sequence through a user interface;
searching a plurality of title data one by one on the user interface, and arranging and vertically stacking data blocks of the title data under the time mark, wherein each of the data blocks includes a title field and a data field, and the data field is disposed under the time mark, and the title data is disposed in the title field; and
displaying or listing a plurality of event data in the matched data fields of the title data according to an event content and a time of occurrence and under the time mark, and sequentially arranging the event data according to the time of occurrence of the events, and comparing the different event data in the data block with one another based on the time marks.

10. The method of displaying or recording events by a time sequence according to claim 9, further comprising the step of adjusting a time range tag under the data block to reduce or enlarge a display range of the time mark and the data field.
